(19) United States
(12) Patent Application Publication
(10) Pub. No.: US 2026/0265134 A1
(43) Pub. Date: Sep. 10, 2026

(54) EXPANDED CLAY AGGREGATE AND METHOD OF PREPARING THE SAME

(71) Applicant: WUHAN UNIVERSITY OF TECHNOLOGY, Wuhan (CN)

(72) Inventors: Pei TANG, Wuhan (CN); Pengjie RONG, Wuhan (CN); Wei CHEN, Wuhan (CN)

(21) Appl. No.: 19/537,307

(22) Filed: Feb. 11, 2026

(30) Foreign Application Priority Data
Mar. 5, 2025 (CN) 202510257780.6

(51) Int. Cl. C04B 18/14; C04B 18/08; C04B 35/645; C04B 111/00

(52) U.S. Cl. CPC C04B 18/146; C04B 18/08; C04B 35/645; C04B 2111/0081; C04B 2235/3206; C04B 2235/3222; C04B 2235/5436; C04B 2235/9661

(57) ABSTRACT

Disclosed are an expanded clay aggregate and a method of preparing the same. The expanded clay aggregate comprises silica-rich solid waste, iron-rich solid waste, alumina-rich solid waste, magnesia-rich solid waste, and a fluxing agent, the silica-rich solid waste, the iron-rich solid waste, the alumina-rich solid waste, the magnesia-rich solid waste, and the fluxing agent are in a mass ratio of 40-50:10-15:20-30:2-12:3-5.

### FIELD

The disclosure relates to the field of solid waste treatment and resource utilization, and specifically relates to an expanded clay aggregate and a method of preparing the same.

### BACKGROUND OF THE DISCLOSURE

With the rapid development of urbanization and industrial production in China, a large amount of industrial solid waste, such as red mud, tailings and phosphogypsum, has been generated, bringing huge pressure to society, the economy, and the environment. How to effectively dispose of solid waste so that it develops in coordination with the economy has become a major problem we face. From the perspective of physical and chemical properties, these solid wastes are potential renewable resources that can be widely used in the production of building materials, metal extraction, etc. While reducing pollution and lowering costs, this also alleviates resource and environmental pressures. Clay aggregates are used in large quantities in engineering applications and have the potential to consume large amounts of solid waste. Therefore, using solid wastes such as red mud, tailings and phosphogypsum to partially or wholly replace traditional natural minerals to prepare clay aggregates has good prospects and markets.

Clay aggregate is a material mainly composed of silicon-aluminum raw materials, obtained by sintering or expanding at high temperatures after obtaining granulated particles through a granulation process. Among them, expanded clay aggregate exhibits significant expansion behavior during the sintering process, having high internal porosity and low density. It possesses advantages of light weight, heat insulation, sound insulation, waterproof and flame retardant. Furthermore, it has low requirements for raw material properties and can consume large amounts of industrial solid waste. Based on these characteristics, expanded clay aggregate can be widely used in the construction and environmental protection industries. Currently, its practical application is often limited due to mechanical performance bottlenecks caused by its internal porous structure. Therefore, improving the mechanical properties of expanded clay aggregate is crucial for enhancing its application level.

### SUMMARY

In view of the above, the present disclosure provides an expanded clay aggregate and a method of preparing the same.

A first aspect of the present disclosure provides an expanded clay aggregate, comprising silica-rich solid waste, iron-rich solid waste, alumina-rich solid waste, magnesia-rich solid waste, and a fluxing agent, the silica-rich solid waste, the iron-rich solid waste, the alumina-rich solid waste, the magnesia-rich solid waste, and the fluxing agent are in a mass ratio of 40-50:10-15:20-30:2-12:3-5.

Further, the silica-rich solid waste is selected from the group consisting of copper tailings and quartz tailings.

Further, the iron-rich solid waste is selected from the group consisting of red mud and steel slag.

Further, the alumina-rich solid waste is selected from the group consisting of fly ash and Kaolin.

Further, the magnesia-rich solid waste comprises magnesite tailings, a content of MgO in the magnesite tailings is greater than 40 wt %.

Further, the fluxing agent is selected from the group consisting of sodium silicate, sodium carbonate, and phosphogypsum.

Further, main crystalline phases of the expanded clay aggregate comprise at least one phase selected from spinel phase, hematite phase, and quartz phase.

Further, the spinel phase is selected from the group consisting of magnesium-iron-aluminum spinel and hercynite.

Further, a chemical composition of the expanded clay aggregate, in terms of mass percentage based on oxides, comprises 45 wt % to 57 wt % of SiO₂, 17 wt % to 22 wt % of Al2O3, 6 wt % to 10 wt % of Fe2O3, 2 wt % to 6 wt % of MgO, 5 wt % to 13 wt % of a total amount of Na2O, K2O and CaO, and 4 wt % to 5 wt % of impurity oxides.

A second aspect of the present disclosure provides a method for preparing the expanded clay aggregate comprising steps of:
putting raw materials into a ball milling and mixing them thoroughly to obtain a uniform mixture;
pouring the mixture into a mold and pressing to obtain a pressed molded sample; and
placing the pressed molded sample into a muffle furnace, heating from 25° C. to 900° C., holding for 5 to 15 minutes, then heating to 1150° C. to 1200° C. and holding for 30 to 60 minutes, and followed by furnace cooling to obtain the expanded clay aggregate.

### BRIEF DESCRIPTION OF DRAWINGS

To describe technical solutions in embodiments of the disclosure more clearly, accompanying drawings required in description of the embodiments will be briefly introduced below. Apparently, the accompanying drawings in the following description merely show some embodiments of the disclosure, and a person of ordinary skill in the art can still derive other accompanying drawings from structures shown in these accompanying drawings without creative efforts.

FIG. 1 is XRD diffraction patterns of the expanded clay aggregate of the Embodiments and Comparative Embodiments of the present disclosure.

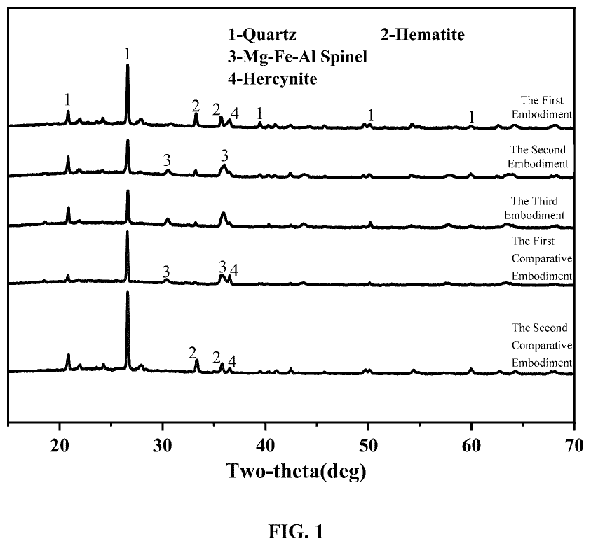

Wherein the labeled phases are: 1, Quartz (PDF #46-1045); 2, Hematite (PDF #33-0664); 3, Mg—Fe—Al Spinel (PDF #21-0540); 4, Hercynite (PDF #82-0583).

### DETAILED DESCRIPTION OF THE DISCLOSURE

The following will provide a further explanation of the present disclosure in conjunction with the accompanying drawings.

An expanded clay aggregate is provided, including silica-rich solid waste, iron-rich solid waste, alumina-rich solid waste, magnesia-rich solid waste, and a fluxing agent. The silica-rich solid waste, the iron-rich solid waste, the alumina-rich solid waste, the magnesia-rich solid waste, and the fluxing agent are in a mass ratio of 40-50:10-15:20-30:2-12:3-5. A chemical composition of the expanded clay aggregate, in terms of mass percentage based on oxides, includes 45 wt % to 57 wt % of SiO2, 17 wt % to 22 wt % of Al2O3, 6 wt % to 10 wt % of Fe2O3, 2 wt % to 6 wt % of MgO, 5 wt % to 13 wt % of a total amount of Na2O, K2O and CaO, and 4 wt % to 5 wt % of impurity oxides.

In some embodiment, the silica-rich solid waste is selected from the group consisting of copper tailings and quartz tailings. In some embodiment, the iron-rich solid waste is selected from the group consisting of red mud and steel slag. In some embodiment, the alumina-rich solid waste is selected from the group consisting of fly ash and Kaolin. In some embodiment, magnesia-rich solid waste comprises magnesite tailings, and the magnesite tailings are used to provide magnesium oxide. In some embodiment, the fluxing agent is selected from the group consisting of sodium silicate, sodium carbonate, and phosphogypsum.

In some embodiment, the copper tailings used are bulk solid waste produced by mines. In the present disclosure, the SiO2 content in the copper tailings is 71.05 wt %, and the Al2O3 content is 11.92 wt %.

The waste residue and wastewater produced during the experimental processing do not require harmless treatment and meet environmental safety requirements, allowing for direct discharge or stockpiling.

In the following embodiments, the particle sizes of the copper tailings, the fly ash, and the red mud are all below 100 mesh, and the chemical compositions are shown in Table 1. It should be understood that the specific raw material compositions described herein are only for explaining the present disclosure and are not intended to limit the present disclosure; various changes (including raw material origins) can be made within the scope defined by the claims of the present disclosure.

TABLE 1
Main Chemical Composition of Raw Materials (wt %)

| Raw | | | | | | | | | | |
|---|---|---|---|---|---|---|---|---|---|---|
| Material | SiO₂ | Al₂O₃ | Fe₂O₃ | CaO | MgO | K₂O | Na₂O | TiO₂ | LOI | Others |
| Copper | 71.05 | 11.92 | 3.28 | 2.90 | 0.88 | 5.36 | 0.41 | 0.32 | 1.45 | 2.43 |
| Tailings | | | | | | | | | | |
| Fly Ash | 53.46 | 35.15 | 2.87 | 1.91 | 0.59 | 1.26 | 0.39 | 1.19 | 2.05 | 1.13 |
| Red Mud | 9.98 | 22.35 | 41.26 | 1.32 | 0.14 | 0.07 | 7.55 | 5.29 | 10.92 | 1.12 |
| Magnesite | 6.37 | 0.64 | 0.42 | 0.85 | 42.94 | 0.00 | 0.00 | 0.00 | 48.45 | 0.33 |

### First Embodiment

A method for preparing the expanded clay aggregate is provided, including the following steps:
S101, weigh the copper tailings, the red mud, the fly ash, the magnesite tailings, and the sodium silicate according to a mass ratio of 48:15:29:3:5, then place them into a mixer for stirring for 10-15 minutes and dry to obtain a uniform mixture. The chemical composition of the mixture comprises 55.28% of SiO2, 19.90% of Al2O3, 8.88% of Fe2O3, 2.21% of CaO, 2.03% of MgO, 3.05% of K2O, 3.99% of Na2O, 4.66% of others.
S102, pour the mixture into a mold and use a dry pressing method to press the mixture into a cylindrical sample of φ20 mm;
S103, place the cylindrical sample in a muffle furnace, first heat from 25° C. to 900° C. at 10° C./min, hold for 10 minutes, then continue to heat to 1180° C. at 10° C./min, hold for 60 minutes, followed by furnace cooling to obtain the expanded clay aggregate.

The obtained expanded clay aggregate has an apparent density of 0.77 g/cm³, compressive strength of 2.73 MPa, specific strength (compressive strength/apparent density) of 3.58, 1 h water absorption rate of 0.28%, sample pore size is distributed in a range of 0.8 to 2 mm, pore size distribution standard deviation (SD) of 0.19, and average pore size of 1.15 mm.

At this stage, the crystalline phases in the expanded clay aggregate are mainly quartz and hercynite, with a small amount of granular spinel microcrystals. The pore density is relatively high, and the open porosity is relatively high.

### Second Embodiment

This Embodiment is substantially the same as the First Embodiment, differing from it in that it is not the same as step S101 in the First Embodiment, as detailed below.

S201, weigh the copper tailings, the red mud, the fly ash, the magnesite tailings, and the sodium silicate according to a mass ratio of 46:15:26:8:5, then place them into a mixer for stirring for 10 minutes to obtain a uniform mixture. The chemical composition of the mixture comprises 54.06% of SiO2, 19.12% of Al2O3, 8.96% of Fe2O3, 2.17% of CaO, 3.95% of MgO, 3.02% of K2O, 4.01% of Na2O, 4.71% of others.

The remaining steps are the same as those in the First Embodiment and thus will not be repeated here.

The obtained expanded clay aggregate has an apparent density of 0.71 g/cm³, compressive strength of 2.56 MPa, specific strength of 3.62, 1 h water absorption rate of 0.37%, sample pore size distributed in a range of 0.6 to 2 mm, pore size distribution standard deviation (SD) of 0.17, and average pore size of 1.08 mm.

Compared with the First Embodiment, the MgO content increased to 3.95 wt %, the specific strength increased by 1.12%, and the pore size standard deviation narrowed by 10.53%.

Quartz and hercynite diffraction peaks in the expanded clay aggregate decrease significantly, and more magnesium-iron-aluminum spinel phases appear. When quartz transforms into spinel crystals, Si4+ enters the glass phase, causing the degree of polymerization of Si—O ion groups in the alkali-rich melt to increase, and the melt viscosity to increase. The increase in viscosity is conducive to the uniform distribution of small pores generated in the foaming stage within the matrix, significantly improving the foaming effect, uniform pore size distribution, and improved pore wall integrity.

### Third Embodiment

This Embodiment is substantially the same as the First Embodiment, differing from it in that it is not the same as step S101 in the First Embodiment, as detailed below.

S301, weigh the copper tailings, the red mud, the fly ash, the magnesite tailings, and the sodium silicate according to a mass ratio of 45:15:24:11:5, then place them into a mixer for stirring for 10 minutes to obtain a uniform mixture. The chemical composition of the mixture comprises 52.60% of SiO2, 18.56% of Al2O3, 9.04% of Fe2O3, 2.12% of CaO, 5.96% of MgO, 2.95% of K2O, 4.03% of Na2O, 4.74% of others.

The remaining steps are the same as those in the First Embodiment and thus will not be repeated here.

The obtained expanded clay aggregate has an apparent density of 0.63 g/cm³, compressive strength of 2.29 MPa, specific strength of 3.63, 1 h water absorption rate of 0.46%, sample pore size distributed in a range of 0.5 to 1.7 mm, pore size distribution standard deviation (SD) of 0.16, and average pore size of 0.97 mm.

Compared with the First Embodiment, the MgO content increased to 5.96 wt %, specific strength increased by 0.28%, and pore size standard deviation narrowed by 5.88%.

At this stage, the crystal phases are basically quartz and magnesium-iron-aluminum spinel phases. Magnesium-iron-aluminum spinel microcrystals are uniformly dispersed in the melt and liquid-gas interface, reducing the liquid-gas contact area and pore nucleation energy, and forming many uniformly distributed micro-pores, improving pore structure and pore wall integrity. The improvement of pore wall integrity not only improves the compressive strength of the expanded clay aggregate but is also beneficial for reducing material water absorption and improving material frost resistance.

### First Comparative Embodiment

This comparative Embodiment is substantially the same as the First Embodiment, differing from it in that it is not the same as step S101 in the First Embodiment, as detailed below.

Weigh the copper tailings, the red mud, the fly ash, the magnesite tailings, and the sodium silicate according to a mass ratio of 43:15:22:15:5, then place them into a mixer for stirring for 10 minutes to obtain a uniformly mixture. The chemical composition of the mixture comprises 51.07% of SiO2, 17.97% of Al2O3, 9.12% of Fe2O3, 2.07% of CaO, 8.07% of MgO, 2.87% of K2O, 4.05% of Na2O, 4.78% of others.

The remaining steps are the same as those in the First Embodiment and thus will not be repeated here.

The obtained expanded clay aggregate has an apparent density of 0.66 g/cm³, compressive strength of 1.91 MPa, specific strength of 2.89, 1 h water absorption rate of 0.63%, sample pore size distributed in a range of 0.5 to 2.3 mm, pore size distribution standard deviation (SD) of 0.28, and average pore size of 1.49 mm.

Compared with the First Embodiment, the MgO content increased to 8.07 wt %, specific strength decreased by 20.39%.

At this stage, the main crystal phases in the matrix are still quartz and spinel phases, but the uneven pore distribution (increased pore size difference) of the sample causes the strength to decrease. At the same time, excessive MgO may not fully participate in the spinel reaction and easily precipitates in the form of periclase, causing the uniformity of the material pore structure to deteriorate and mechanical properties to decline.

### Second Comparative Embodiment

This comparative Embodiment is substantially the same as the First Embodiment, differing from it in that it is not the same as step S101 in the First Embodiment, as detailed below.

Weigh the copper tailings, the red mud, the fly ash, the magnesite tailings, and the sodium silicate according to a mass ratio of 50:15:30:0:5, then place them into a mixer for stirring for 10 minutes to obtain a uniformly mixture. The chemical composition of the mixture comprises 56.37% of SiO2, 20.16% of Al2O3, 8.82% of Fe2O3, 2.26% of CaO, 0.65% of MgO, 3.12% of K2O, 3.98% of Na2O, 4.64% of others.

The remaining steps are the same as those in the First Embodiment and thus will not be repeated here.

The obtained expanded clay aggregate has an apparent density of 0.84 g/cm³, compressive strength of 1.89 MPa, specific strength of 2.25, 1 h water absorption rate of 0.30%, sample pore size distributed in a range of 1.2 to 4.5 mm, pore size distribution standard deviation (SD) of 0.72, and average pore size of 2.3 mm.

When the magnesium oxide content is 0.65 wt %, the crystalline phases in the sample contain a large amount of quartz and hercynite phases. Studies indicate that during pore expansion and growth, excessive quartz and hercynite phases significantly increase the liquid phase viscosity, hindering pore growth and decreasing the uniformity of sample pore size, resulting in very high open porosity. Table 2 summarizes the test data for all embodiments and comparative examples.

TABLE 2

| | | | | Apparent | Compressive | |
|---|---|---|---|---|---|---|
| | | Mineral | Pore | Density | Strength | Specific |
| Item | MgO(wt %) | Composition | Size(mm) | (g/cm³) | (MPa) | Strength |
| First | 2.03 | SiO₂, Fe₂O₃ | 1.15 | 0.77 | 2.73 | 3.58 |
| Embodiment | | Fe—Al spinel | | | | |
| Second | 3.95 | SiO₂, Fe₂O₃, | 1.08 | 0.71 | 2.56 | 3.62 |
| Embodiment | | Mg—Fe—Al | | | | |
| | | spinel | | | | |
| Third | 5.96 | SiO₂, Mg—Fe—Al | 0.97 | 0.63 | 2.29 | 3.63 |
| Embodiment | | spinel | | | | |
| First | 8.07 | SiO₂, Mg—Fe—Al | 1.49 | 0.66 | 1.91 | 2.89 |
| comparative | | spinel, Fe—Al | | | | |
| Embodiment | | spinel | | | | |
| Second | 0.65 | SiO₂, Fe₂O₃, | 2.30 | 0.84 | 1.89 | 2.25 |
| comparative | | Fe—Al spinel | | | | |
| Embodiment | | | | | | |

The mechanism of the present disclosure is: by controlling the content of MgO to change the Mg/Al and Mg/Fe ratios, it interacts with Al2O3 and Fe2O3 in the red mud at high temperatures to regulate the generation of spinel microcrystals. When magnesite tailings are added, MgO can reduce the high-temperature liquid phase viscosity and broaden the sintering temperature range, making the pore structure uniform and generating magnesium-iron-aluminum spinel microcrystals. The granular spinel size is small (1-5 μm), possessing good high-temperature fluidity, which can promote uniform pore growth and improve pore wall integrity, thereby obtaining expanded clay aggregate with excellent mechanical properties and uniform pore structure, conducive to promoting the diversified utilization of expanded clay aggregate.

Compared with the prior art, the beneficial effects of the present disclosure are:

The present disclosure synergistically utilizes solid wastes such as fly ash, copper tailings, red mud, and phosphogypsum, exploring suitable raw material ratios of fly ash, copper tailings, and red mud for preparing expanded clay aggregate. This greatly improves the solid waste consumption rate, reduces preparation costs, involves a simple process, is green and environmentally friendly, and has good socio-economic and environmental benefits, conducive to promoting the diversified utilization of expanded clay aggregate.

The present disclosure adopts a press molding method. The expanded clay aggregate has high strength and low moisture content, reducing energy consumption in the pre-drying process and storage costs, providing significant economic benefits, and helping to improve the feasibility of in-situ conversion of solid waste into clay aggregate.

The present disclosure proposes introducing magnesite tailings to regulate the crystal phase of the clay aggregate to generate spinel microcrystals, thereby improving the mechanical properties of the clay aggregate. At high temperatures, MgO can react with Fe2O3 and Al2O3 to form a spinel phase and promote stable pore growth. Micro-granular spinel is beneficial for improving pore stability and uniformity, and possesses a wider sintering temperature range, effectively improving the strength of the expanded clay aggregate.

The expanded clay aggregate obtained by the present disclosure has good internal pore wall integrity and a high degree of foaming, possessing good pore structure and mechanical properties, which is conducive to reducing the water absorption of the material and enhancing the durability of the material's application.

The present disclosure uses magnesite tailings to provide magnesium oxide, greatly reducing production costs, and the solid waste utilization rate can reach 80%.

The spinel phase generated in the present disclosure is conducive to the effective solidification of heavy metals in minerals, and the waste residue and wastewater produced during the experimental processing do not require harmless treatment and meet environmental safety requirements.

The expanded clay aggregate prepared by the present disclosure has an apparent density in a range of 0.63 to 1.20 g/cm³, a compressive strength in a range of 1.5 to 3.6 MPa, and a one-hour water absorption rate in a range of 0.32 to 0.89%. Within a certain range, the specific strength (compressive strength/apparent density) increases significantly with the increase of MgO content. The amorphous phase contents of samples with MgO contents of 0.65 wt %, 2.03 wt %, 3.95 wt %, 5.96 wt %, and 8.07 wt % measured by XRD pattern fitting are: 51.81%, 56.25%, 60.36%, 61.79%, and 59.86%, respectively. XRD shows that before the MgO content reaches 6%, its increase can promote the formation of the high-temperature liquid phase of the clay aggregate body. The diffraction peak intensity of the quartz phase gradually decreases, and the magnesium-iron-aluminum spinel phase is enhanced. At the same time, the increase in the liquid phase can fill grain boundaries and pores, optimize the ratio of the crystal phase (such as spinel) to the glass phase, and enhance structural uniformity. When the MgO content reaches 8%, the amorphous phase content decreases, and the quartz phase diffraction peak increases, indicating that excessive MgO content cannot continuously promote liquid phase generation. That is, the introduction of MgO must be within an appropriate range. Therefore, a reasonable dosage can improve the crystal phase to liquid phase ratio and microstructure, further homogenize the pores while ensuring foaming, and maximize the strength of the clay aggregate.

Although the disclosure has been described with reference to preferred embodiments, various modifications may be made thereto and equivalents may be substituted for parts thereof without departing from the scope of the disclosure. In particular, the technical features mentioned in the various embodiments can be combined in any way if there are no structural conflicts. the disclosure is not limited to the specific embodiments disclosed herein but encompasses all technical solutions falling within the scope of the claims.

1. An expanded clay aggregate, comprising silica-rich solid waste, iron-rich solid waste, alumina-rich solid waste, magnesia-rich solid waste, and a fluxing agent, the silica-rich solid waste, the iron-rich solid waste, the alumina-rich solid waste, the magnesia-rich solid waste, and the fluxing agent are in a mass ratio of 40-50:10-15:20-30:2-12:3-5, the silica-rich solid waste comprises copper tailings, the iron-rich solid waste comprises red mud, the alumina-rich solid waste comprises fly ash, and the magnesia-rich solid waste comprises magnesite tailings, a content of MgO in the magnesite tailings is greater than 40 wt %, and a chemical composition of the expanded clay aggregate, in terms of mass percentage based on oxides, comprises 45 wt % to 57 wt % of SiO₂, 17 wt % to 22 wt % of Al₂O₃, 6 wt % to 10 wt % of Fe₂O₃, 2 wt % to 6 wt % of MgO, 5 wt % to 13 wt % of a total amount of Na₂O, K₂O and CaO, and 4 wt % to 5 wt % of impurity oxides.

2. The expanded clay aggregate according to claim 1, wherein the fluxing agent is selected from the group consisting of sodium silicate and sodium carbonate.

3. The expanded clay aggregate according to claim 1, wherein main crystalline phases of the expanded clay aggregate comprise at least one phase selected from spinel phase, hematite phase, and quartz phase.

4. The expanded clay aggregate according to claim 3, wherein the spinel phase is selected from the group consisting of magnesium-iron-aluminum spinel and hercynite.

5. A method for preparing the expanded clay aggregate according to claim 1, comprising steps of:
putting raw materials into a ball milling and mixing to obtain a mixture;
pouring the mixture into a mold and pressing to obtain a pressed molded sample; and
placing the pressed molded sample into a muffle furnace, heating from 25° C. to 900° C., holding for 5 to 15 minutes, then heating to 1150° C. to 1200° C. and holding for 30 to 60 minutes, and followed by furnace cooling to obtain the expanded clay aggregate.
